(19) United States
(12) Patent Application Publication
(10) Pub. No.: US 2003/0014329 A1
(43) Pub. Date: Jan. 16, 2003

(54) System and method for cataloguing

(76) Inventors: Samuel Weisman, Ramat Gan (IL); Eliezer Baron, Ramat Gan (IL)

Correspondence Address: Richard P Berg, Ladas & Parry, Suite 2100, 5670 Wilshire Boulevard, Los Angeles, CA, 90036-5679, US

(21) Appl. No.: 10/203,287

(22) PCT Filed: Feb. 5, 2001
(86) PCT No.: PCT/IL01/00114

(30) Foreign Application Priority Data
Feb. 10, 2000 (IL) 134481

(51) Int. Cl. G06F 17/60

(52) U.S. Cl. 705/26

(57) ABSTRACT

The invention provides a system for cataloguing, displaying and retrieving information and for ordering and acquiring spare parts and/or accessories for vehicles for locomotion by land, by air or by water, the system incorporating (1) a host processor, including (a) means for entering and storing alphanumeric data and graphics concerning the general characteristics of a vehicle and the parts and accessories thereof; (b) means for arranging the spare parts and accessories into groups and sectors in accordance with their locations within the structure, or functions of, the vehicle; (c) means for entering data concerning the availability and cost of the spare parts and accessories; (d) means enabling the selection of a specific spare part or accessory and for displaying data and/or graphics from means (b) and (c), and (2) terminals connectable to communication networks for ordering selected spare parts and/or accessories from manufacturers and/or distributors. The invention also provides a method for using the described system.

### FIELD OF THE INVENTION

The present invention relates to a system and a method associated with Internet services for cataloguing, displaying and retrieving information, ordering and acquiring spare parts and/or accessories for vehicles for locomotion by land, air or water, in particular for land vehicles.

While the following description will specifically relate to land vehicles for reasons of clarity and the fact that spare parts and accessories for such vehicles are the most widely used and thus better understood, it should be noted that the present invention is intended to also encompass other types of vehicles for locomotion.

### BACKGROUND OF THE INVENTION

At present, the major tool available for users of spare parts and accessories for vehicles is a manufacturer's catalogue, provided either by the manufacturer of the vehicles and/or the manufacturer of the spare parts and accessories. Such a catalogue comprises only a list describing the parts, each of which is associated with an identification number or letter/number combination, and is similar in appearance to a telephone directory. The main drawbacks of these catalogues, and various operations and activities based thereon, are as follows:

1. There is no logical unity and/or set standard between the different manufacturers as to the way such a catalogue is arranged, in relation to identification of parts, neither by shape nor by name.

2. Arrangement of such a catalogue, in general, is built on a combined format according to groups of spare parts or systems, fully spread out. Every manufacturer's catalogue is arranged according to his own editing method and plan. This fact requires one to seriously learn the way each catalogue is arranged before studying it. For example, in Catalogue A, an electric fan for cooling a radiator is presented in “cooling systems,” next to “radiator.” In Catalogue B, it is presented as a part of an “electrical system.”

3. The way the present catalogues are arranged, in all of the versions, is not suited to the requirements for ordering spare parts, neither from the point of view of quantities, nor are they suited to the order in which a vehicle is repaired.

4. Study of a catalogue for the purpose of ordering parts requires the simultaneous action of separately listing every item in order to prepare an order.

5. The catalogues are not arranged in a way which is suitable for purchasing inventory for spare parts warehouses.

6. The existing catalogues, in all of the versions, do not relate to specific models one by one. The user must study supplementary material describing the required item number, for each model separately. The supplementary material sometimes appears in a separate explanatory catalogue and sometimes in long textual explanations within the body of a catalogue. In a case where a list has to be prepared, the process is convoluted and slow, and requires adroitness and professionalism.

7. The catalogues are crowded with an overabundance of data requiring study, in spite of the fact that most of this data (80%) is very rarely needed and some is not needed at all.

8. Because of the multiplicity of sub-models on the one hand, and the use of identical systems in different models and sub-models on the other, the present method requires the production of a large quantity of catalogues for each model, presenting duplicate systems and catalogue numbers for use in identical systems (motors, gear boxes, etc.).

9. Because the present system is complicated, and because of the vast world-wide distribution, the catalogues are produced in a limited number of languages.

10. The present catalogues and their production are limited, in the case of:

a) Production error requires exchanging all of the written material and/or shipment of replacement pages, in world-wide distribution

b) Changes in catalogue numbers, determined by the manufacturer, require the production of annexes and reference to previous catalogue numbers, in world-wide distribution.

11. The catalogues are mostly available only to the vehicle manufacturers' representatives.

12. According to the present method, no single entity has a real possibility to equip itself with every catalogue of every manufacturer of every annual model and sub-model (thousands of catalogues).

13. Production of the catalogues is accompanied by a complicated logistic process, requiring distribution to all of the factors, follow-up, collection of funds, availability, and depreciation.

14. The catalogues do not include technical information, which is produced separately, installation instructions or manual, etc., including specific tools required. Similarly, it is not possible to locate an item in a catalogue by means of existing installation instructions.

15. The catalogues do not include information regarding the way in which a part is supplied, such as packaging, quantity of units in each package, measurements and weight, volume, storage and transport instructions (fragility), etc. The catalogues also do not even include the quantity of units of any item in a vehicle.

16. The catalogues do not supply information regarding availability of the parts according to their specific catalogue numbers, in stock, in manufacture, and the manner in which they are installed (as separate parts or only as parts of an entire assembly). For example, there is no possibility to receive information from the catalogue as to whether a vehicle mirror, which is constructed of five separate parts, is supplied as a unit, or if it is possible to purchase its components separately.

17. The catalogues are completely separate from the price lists. After the required part is located, separate study of a price list is required.

18. The catalogues do not include original accessories and/or tires and other options.

19. The catalogues do not allow cross-reference regarding appropriate original parts which may be installed in the vehicles of other manufacturers.

20. Most of the existing catalogues do not give a verbal description alongside the drawings of parts.

21. The catalogues do not facilitate identification of a part only by its catalogue number, but rather the user has first to identify the manufacturer's name in order to select the catalogue in which the part appears.

### DISCLOSURE OF THE INVENTION

It is therefore a broad object of the present invention to overcome the above-described and other drawbacks of catalogues for spare parts and accessories for vehicles.

It is a further object of the present invention to provide a system and method for electronically cataloguing, displaying and retrieving information and for ordering and acquiring spare parts and accessories for vehicles.

It is a still further object of the present invention to provide a system and method for electronically cataloguing, displaying and retrieving information and for ordering and acquiring spare parts and accessories for vehicles and for facilitating direct communication between the manufacturers, dealers or distributors of the vehicles and/or parts and accessories and their intermediate or final users.

It is a still further object of the present invention to provide a system and method for electronically cataloguing, displaying and retrieving information and for ordering and acquiring spare parts and accessories for vehicles and for providing both identification indicia, such as catalogue numbers, as well as a graphic display showing the specific parts and their disposition within the vehicle.

In accordance with the present invention, there is therefore provided a system for cataloguing, displaying and retrieving information and for ordering and acquiring spare parts and/or accessories for vehicles for locomotion by land, by air or by water, said system comprising a host processor, including (a) means for entering and storing alphanumeric data and graphics concerning the general characteristics of said vehicle and the spare parts and accessories thereof; (b) means for arranging said spare parts and accessories into groups and sectors in accordance with their locations within the structure, or functions of, said vehicle; (c) means for entering data concerning the availability and cost of said spare parts and accessories; (d) means enabling the selection of a specific spare part or accessory and for displaying data and/or graphics from means (b) and (c), and terminals connectable to communication networks for ordering selected spare parts and/or accessories from manufacturers and/or distributors.

The invention also provides a method for cataloguing, displaying and retrieving information and for ordering and acquiring spare parts and/or accessories for vehicles for locomotion by land, by air or by water, said method comprising: (a) providing a host processor; (b) entering and storing data and graphics concerning the general characteristics of said vehicles and of the spare parts and accessories belonging to said vehicles; (c) arranging said spare parts and accessories into groups and sectors in accordance with their structural locations in said vehicles, or the functions of said sectors; (d) entering information concerning the availability of said spare parts and accessories from different manufacturers and/or distributors, and their cost; (e) displaying and selecting one or more of said spare parts and/or accessories, and (f) ordering the selected spare parts and/or accessories through a communications network.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a schematic block diagram showing the catalogue system according to the present invention;

FIGS. 2 to 12 illustrate possible screen displays during the various stages of utilizing the system of FIG. 1, and

FIG. 13 is a flow diagram accompanied by illustrations of selected FIGS. 2 to 12, showing the method according to the present invention.

### DETAILED DESCRIPTION

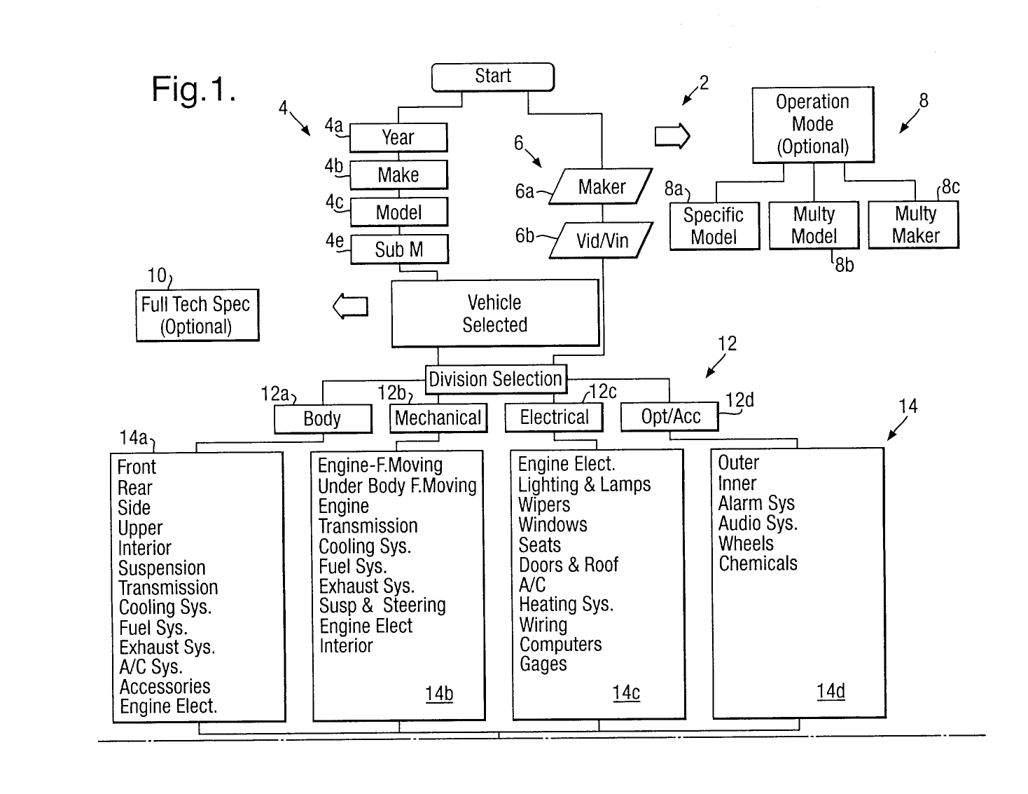

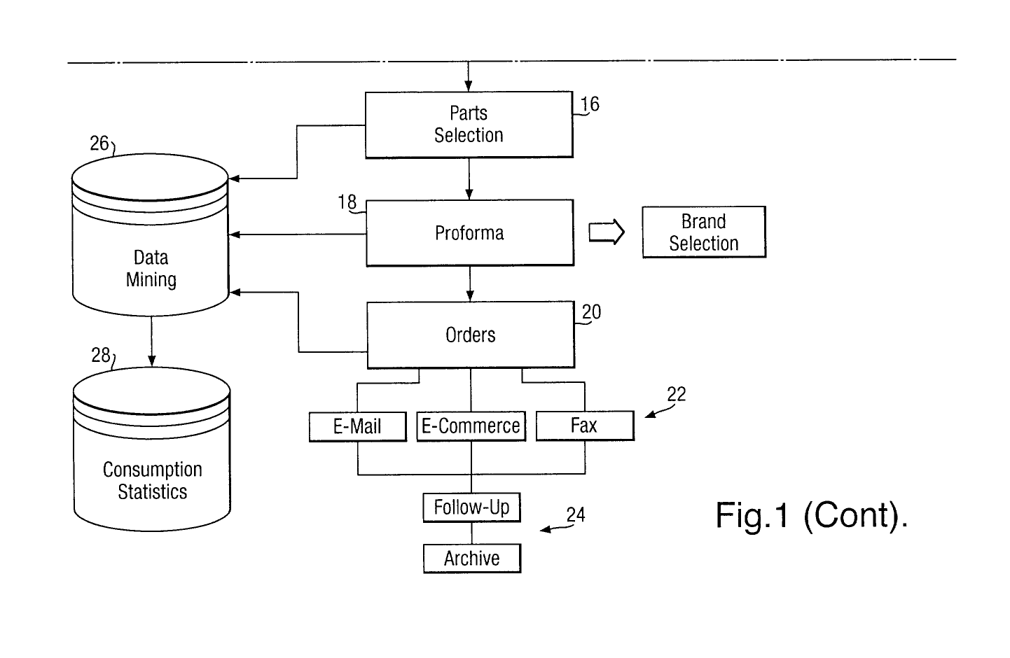

In FIG. 1 there is illustrated a system 2 and method for cataloguing, displaying and retrieving information, and for ordering and acquiring spare parts and/or accessories (hereinafter referred to as “item”) for land vehicles. The main categories of which system 2 is comprised include vehicle identification data 4 and, optionally, vehicle selection 6 by means of name of manufacturer 6a and the vehicle's identification (Vid) or the vehicle's identification number (Vin) 6b. The system also provides an optional feature, whereby the user can select the operation mode 8 to activate the system in accordance with the specific model 8a, models 8b, or multi-manufacturer 8c of an item.

During the step of identifying the desired vehicle, it is possible to enter additional, optional desired characteristics into the system 2. This can be effected by means 10 defining such features as type and size of engine, type of transmission (automatic or manual), etc.

The system is now ready to accept more specific characterization concerning the item sought. For this purpose, the system classifies the items according to divisions 12, such as “body” 12a, “mechanical” 12b, “electrical” 12c, and “optional accessories” 12d. The divisions 12 themselves are further sub-classified into more specific sub-divisions 14, mainly relating to vehicle assemblies, such as division 14a for body sections such as front portions, rear portions, etc.; sub-division 14b for engine, transmission, etc.; sub-division 14c for electrical systems operating windows, wipers, etc.; and sub-division 14d for optional accessories such as audio and alarm systems, etc.

The user selects the desired item at 16, whereupon the system exhibits at 18 a pro forma display of the available items according to manufacturer and cost. An actual order can then be placed at order arrangement 20, and sent to the supplier through any available communication channel over network 22. Follow-up and storage means 24 facilitate monitoring of the operation and conclusion of transactions, including printing reports, invoices and the like, as well as printing complete catalogues according to the invention.

System 2 may advantageously be equipped with data collection means 26 and consumption statistics processor 28, providing information concerning the actual needs of users, thus eventually facilitating the introduction of adjustments or rearrangement of the catalogue displays in accordance with changes in actual global requirements over time.

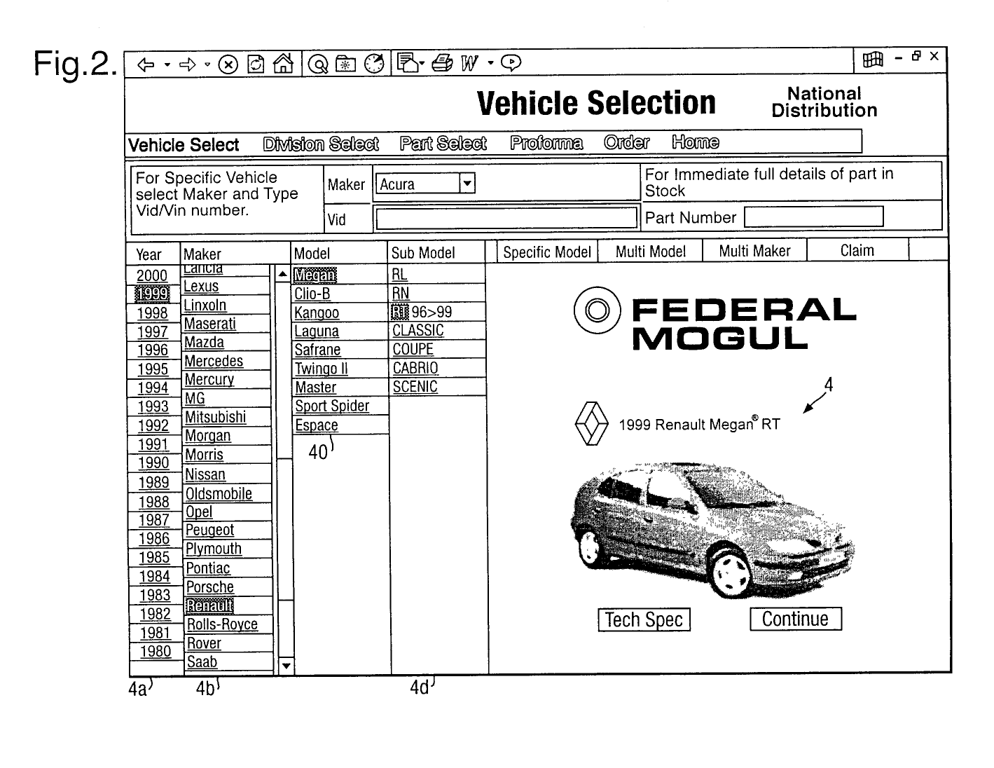

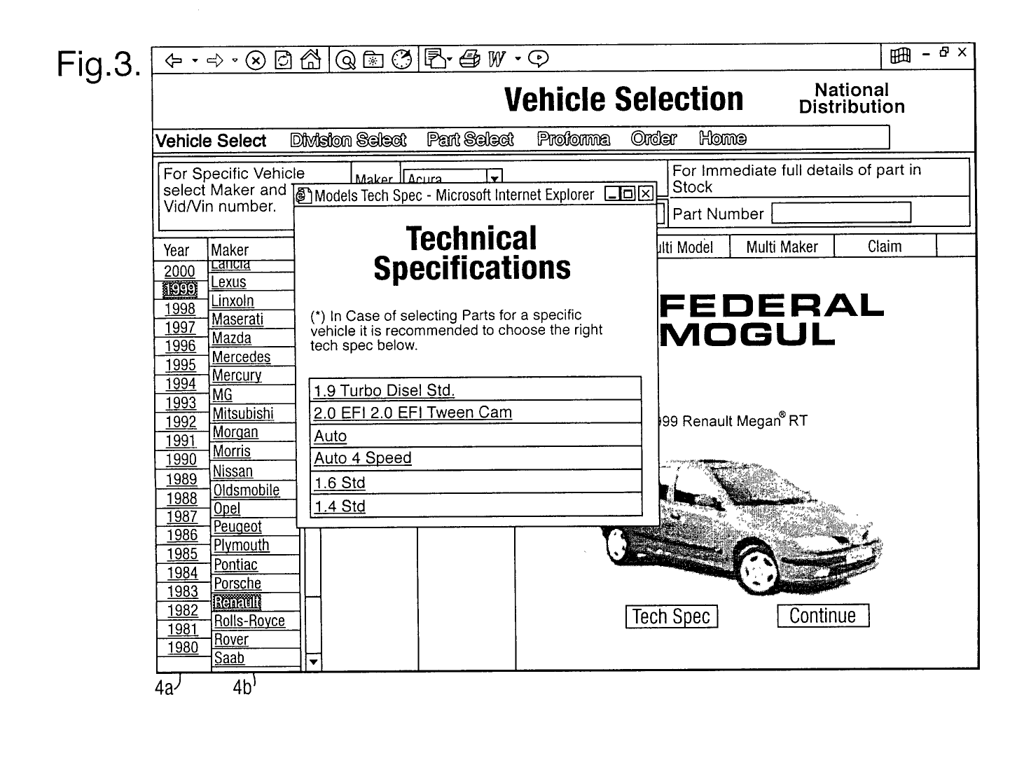

Referring now also to FIGS. 2 to 12, the invention will be described in greater detail, while providing actual illustrations of possible displays on user terminals communicating with the system. Upon entering the system, vehicle identification data 4 includes a menu for entering the vehicle's year of manufacture 4a, the manufacturer's name 4b, the name of the model 4c, sub-model designation 4d. The image of the selected vehicle of interest is advantageously displayed (FIG. 2). The user may then wish to obtain further information concerning the technical specification of the selected vehicle, which information is contained in the system and can be retrieved (FIG. 3).

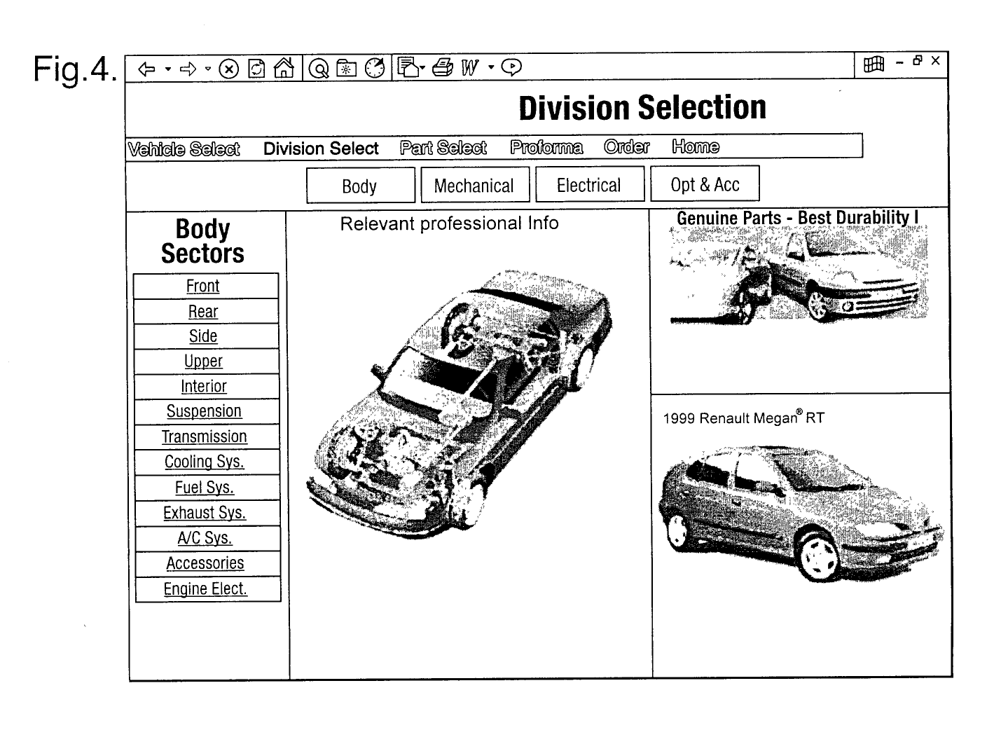

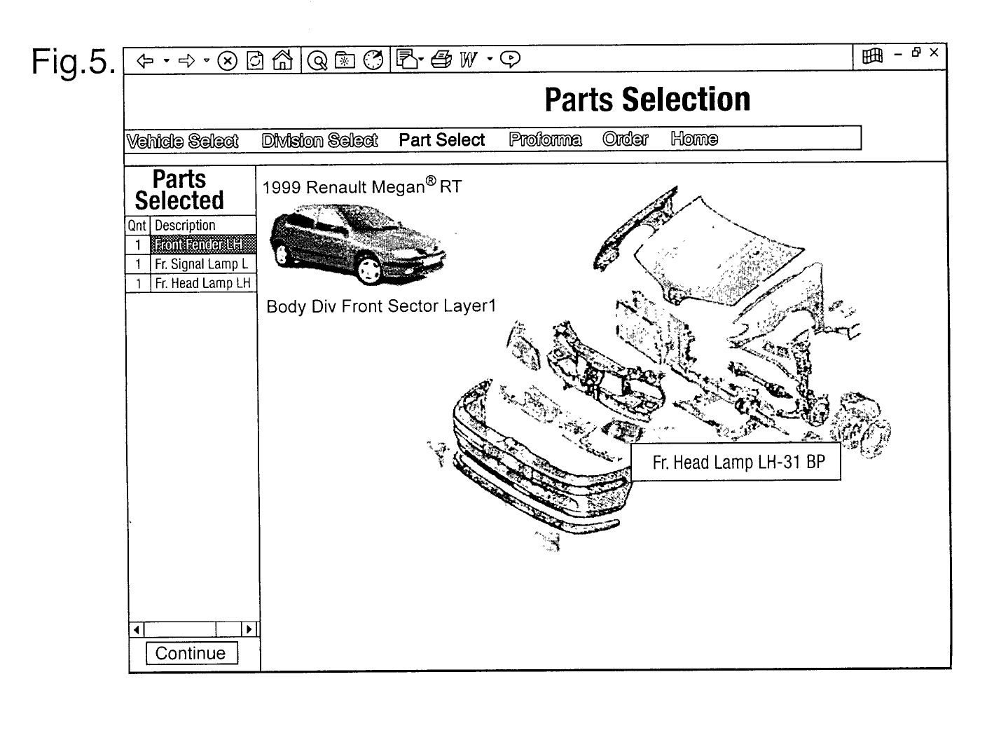

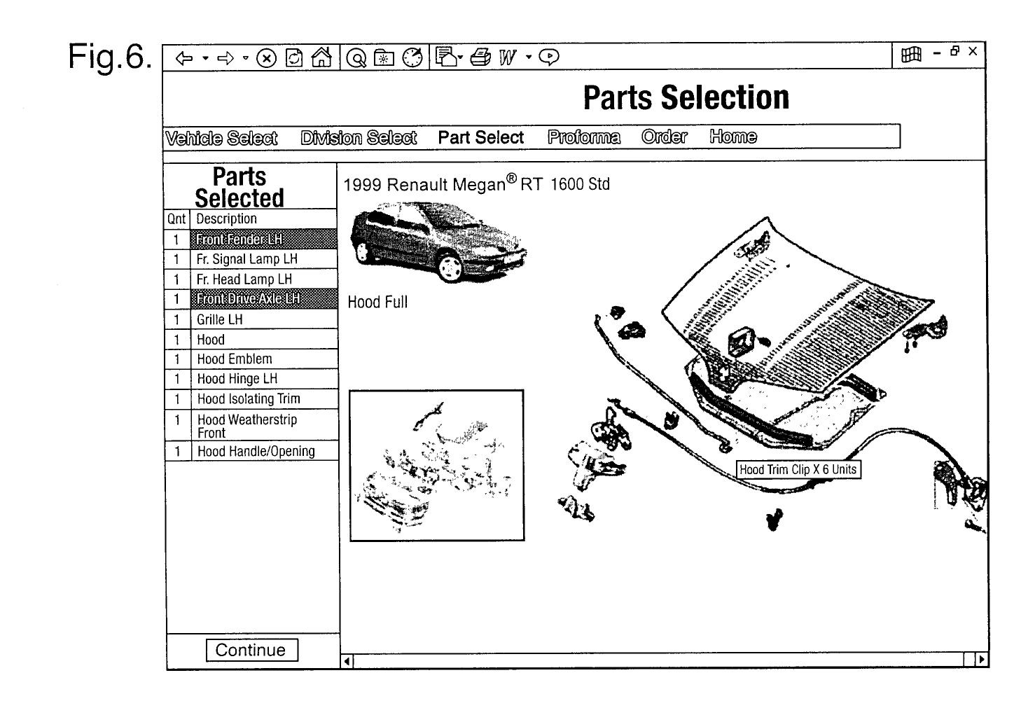

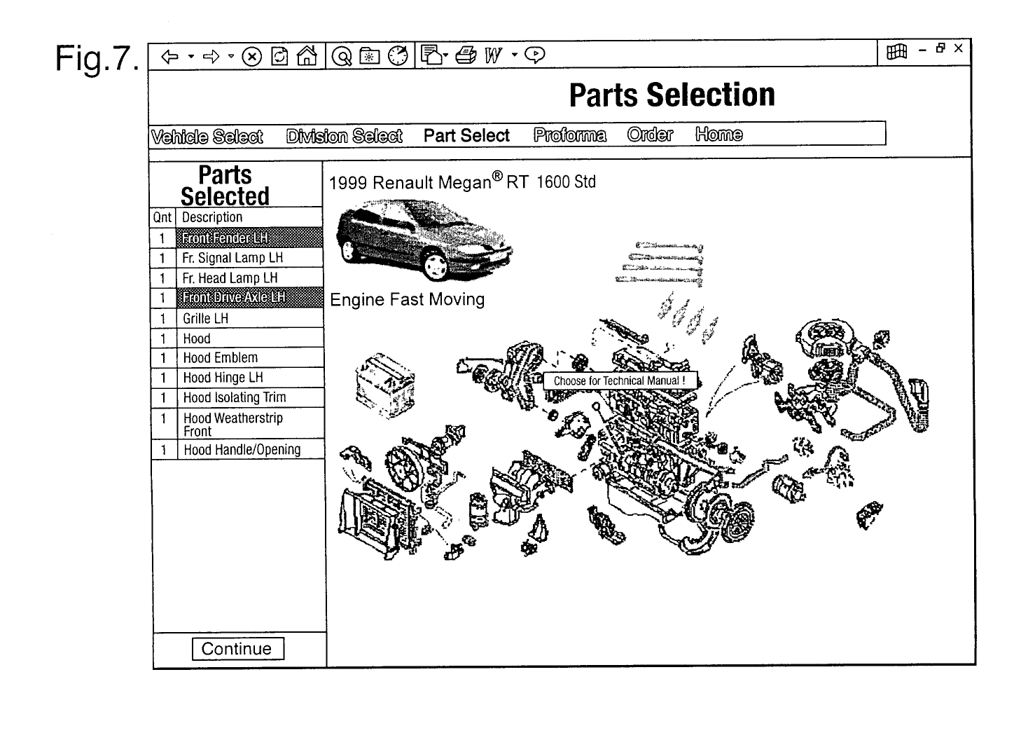

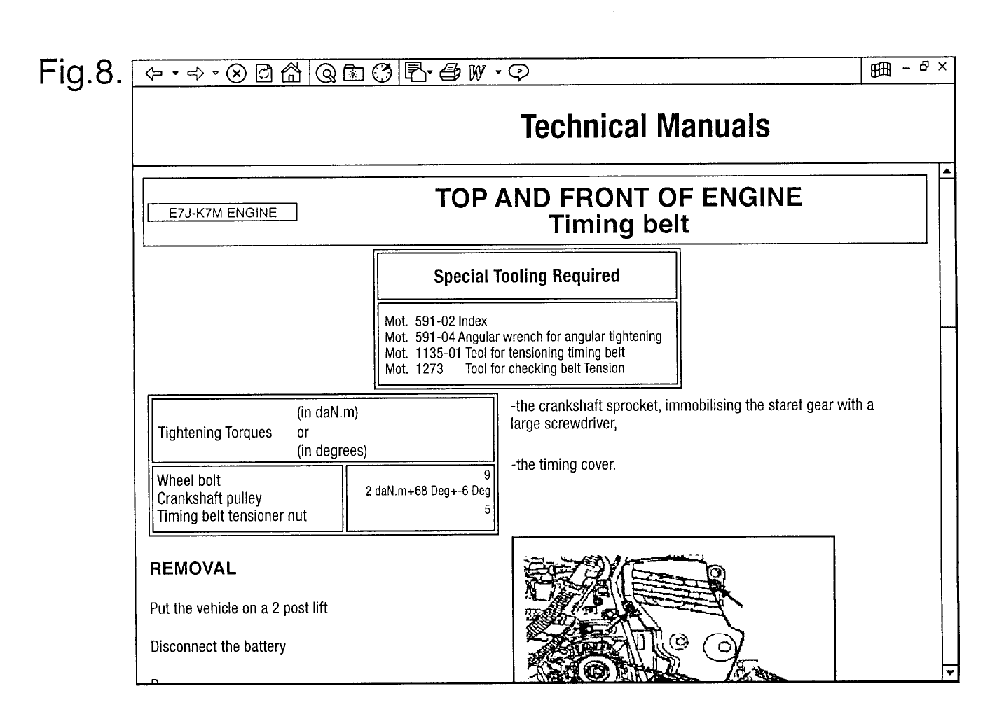

The selected body sector of sub-division 14a can be displayed on the user's screen as shown in FIG. 4. After choosing the vehicle's sector of interest, which in the example shown is the body section containing the sought-after item, the item selection is performed at 16. This operation displays (FIG. 5) the items included in the selected body section in layers representing the relative frequency of consumption of these items, e.g., super-fast moving, fast-moving or slow-moving items. The user may enter any layer desired in order to retrieve information, as seen in FIG. 6. The user may choose to be informed with regard to all items or parts associated with, for example, the hood assembly of a specific vehicle model, or, as seen in FIG. 7, an engine. For ease of identification, the display of the items or parts may be color-coded to highlight, e.g., the fast-moving items. Another useful optional feature of the system is its ability to provide instructions for assembling or disassembling the subject item, including a description of the tools required in order to do so (FIG. 8).

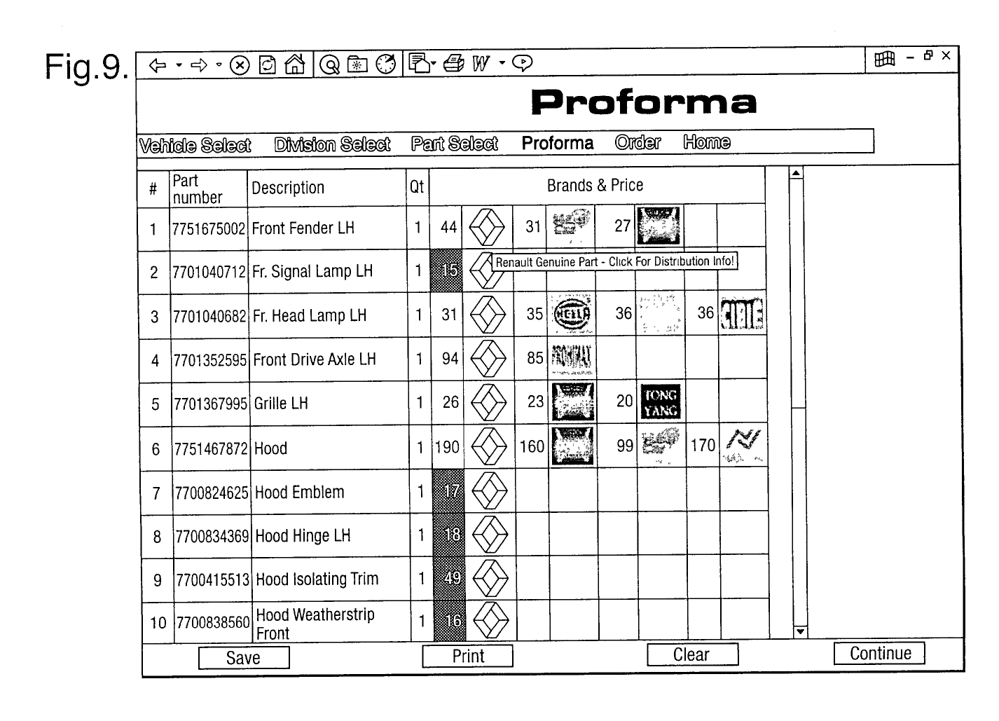

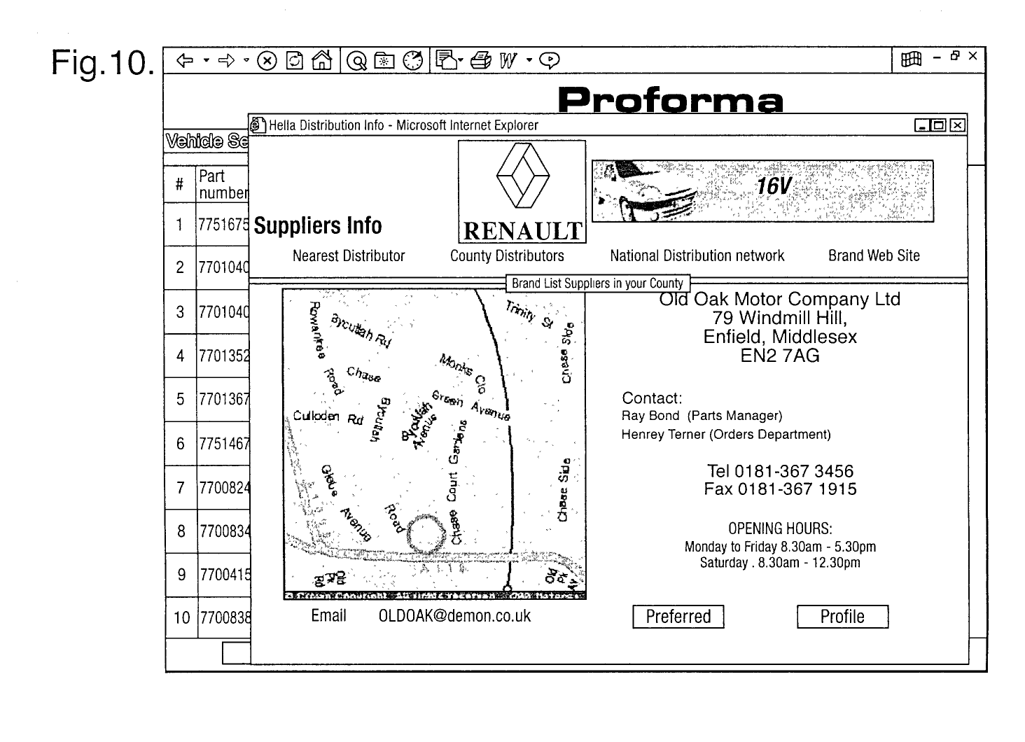

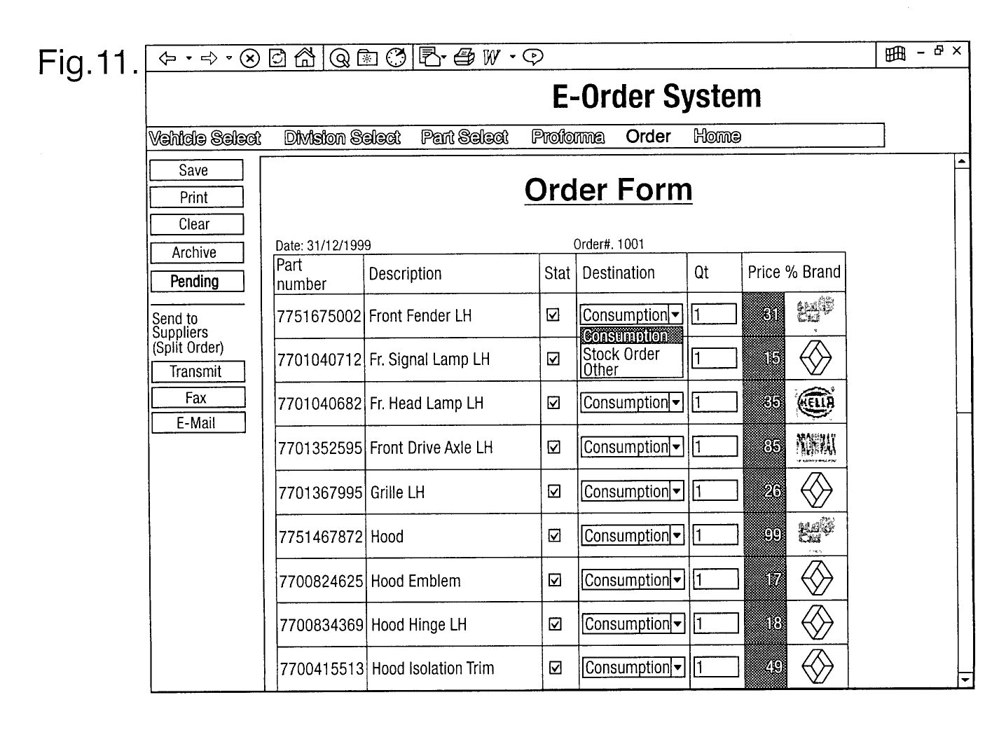

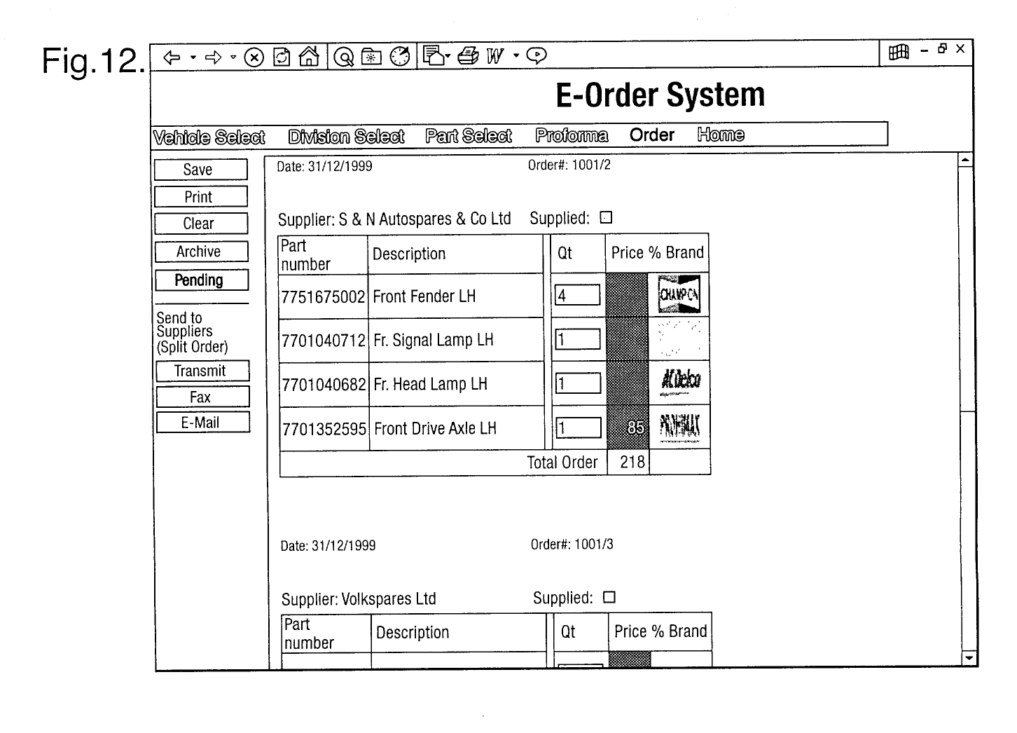

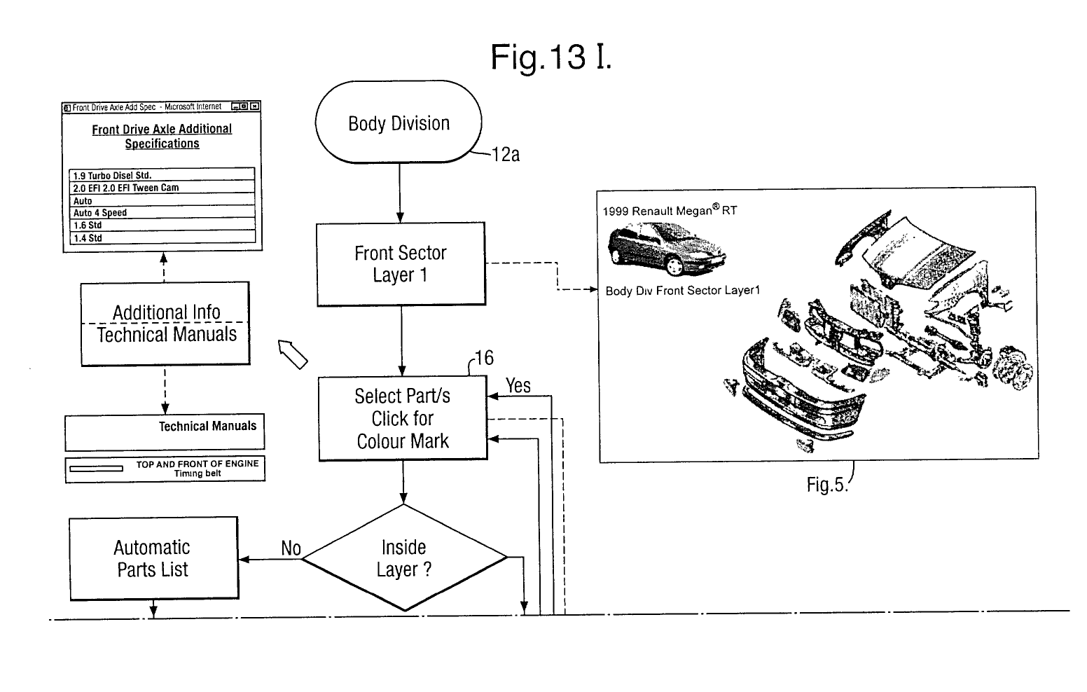

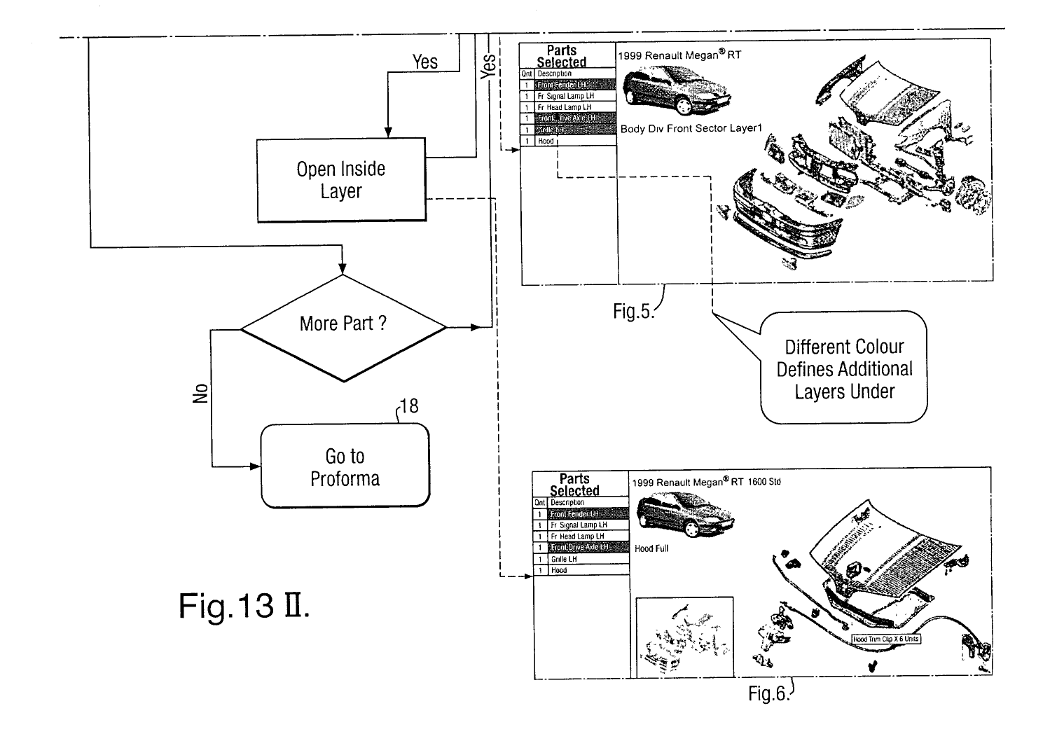

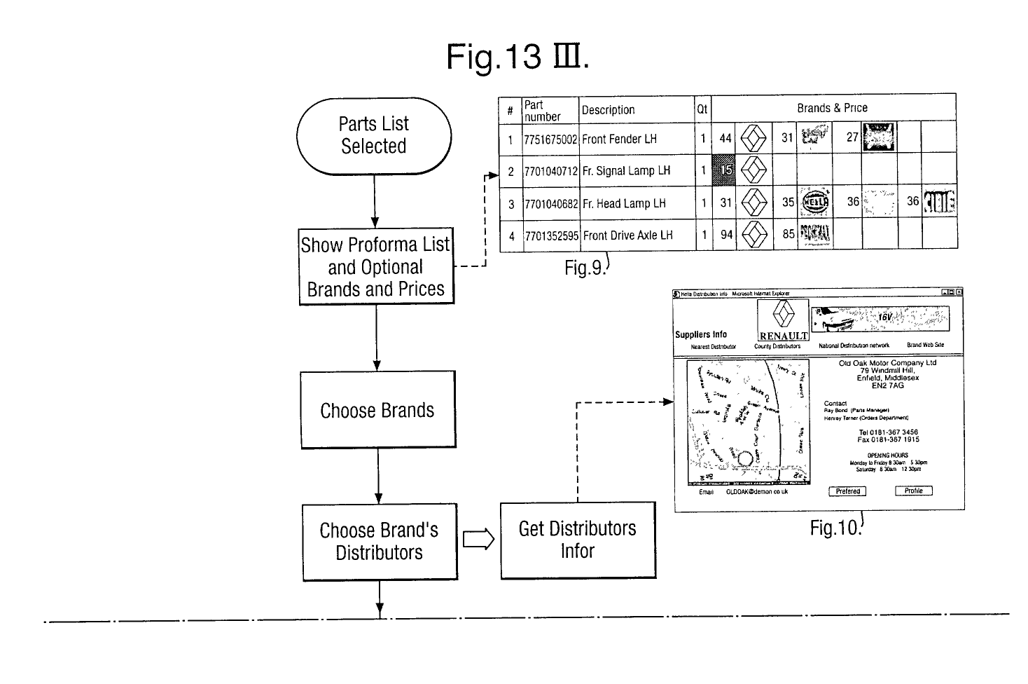

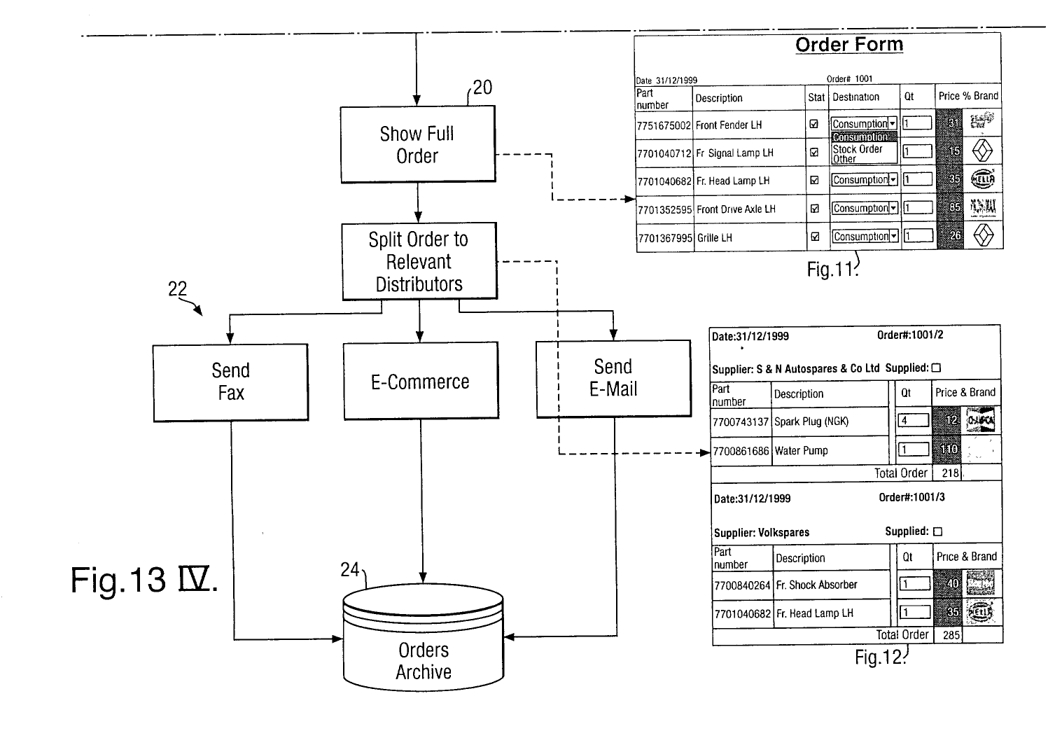

At this stage, the user, may wish to be informed for comparison purposes with regard to the availability of a specific item from all of its manufacturers or distributors, and its cost (FIG. 9), thus entering or displaying the pro forma screen 18. Should the user wish to place an order for a selected item manufactured and/or distributed by a specific dealer, the user may easily determine the closest location where the item is available for purchase. The address displayed may be accompanied by a display showing a map of the area of the closest location (FIG. 10). The actual transaction can now be accomplished by means of the order placement arrangement 20, including order forms (FIGS. 11 and 12). The order is then transmitted over the network 22, through any known route.

FIG. 13 illustrates the method for cataloguing, displaying and retrieving information, and for ordering and acquiring items for vehicles according to the present invention as described above, accompanied by some of the Figures for ease of understanding.

The aspects of sales transactions and the exact manner in which the proprietors of the subject system and method are paid, are known per se and need not be specified.

It will be evident to those skilled in the art that the invention is not limited to the details of the foregoing illustrated embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A system for cataloguing, displaying and retrieving information and for ordering and acquiring spare parts and/or accessories for vehicles for locomotion by land, by air or by water, said system comprising:
1) a host processor, including:
a) means for entering and storing alphanumeric data and graphics concerning the general characteristics of a vehicle and the spare parts and accessories thereof;
b) means for arranging said spare parts and accessories into groups and sectors in accordance with their locations within the structure, or functions of, said vehicle;
c) means for entering data concerning the availability and cost of said spare parts and accessories;
d) means enabling the selection of a specific spare part or accessory and for displaying data and/or graphics from means (b) and (c), and
2) terminals connectable to communication networks for ordering selected spare parts and/or accessories from manufacturers and/or distributors.

2. The system as claimed in claim 1, wherein the general characteristics of said data and graphics include indicia selected from the group of data relating to the vehicle's year of manufacture, the make, model, sub-model, vehicle identification and vehicle identification number, and means associating a specific vehicle with all of the spare parts and accessories belonging to that vehicle.

3. The system as claimed in claim 1, wherein said processor includes means for arranging said data and associated graphics on a single screen for ease of identification of said parts and accessories.

4. The system as claimed in claim 1, wherein said processor comprises means for monitoring and arranging data according to the relative frequency of consumption of said spare parts and accessories and for displaying said parts and accessories in accordance with said frequency of consumption.

5. The system as claimed in claim 4, wherein said data and/or graphics is displayed in color codes according to the relative frequency of consumption.

6. The system as claimed in claim 1, wherein said terminals are connectable to a network associated with Internet services.

7. A method for cataloguing, displaying and retrieving information and for ordering and acquiring spare parts and/or accessories for vehicles for locomotion by land, by air or by water, said method comprising:
a) providing a host processor;
b) entering and storing data and graphics concerning the general characteristics of said vehicles and of the spare parts and accessories belonging to said vehicles;
c) arranging said spare parts and accessories into groups and sectors in accordance with their structural locations in said vehicles, or the functions of said sectors;
d) entering information concerning the availability of said spare parts and accessories from different manufacturers and/or distributors, and their cost;
e) displaying and selecting one or more of said spare parts and/or accessories, and
f) ordering the selected spare parts and/or accessories through a communications network.

8. The method as claimed in claim 7, wherein said data and graphics concerning the general characteristics of said vehicles are selected from the group relating to the vehicle's year of manufacture, the make, model, sub-model, vehicle identification and vehicle identification number, and data associating a specific vehicle with all of the spare parts and accessories belonging to that vehicle.

9. The method as claimed in claim 7, wherein said data and associated graphics of one or more spare parts and/or accessories are arranged and displayed on a single screen.

10. The method as claimed in claim 7, further comprising arranging said data and graphics of one or more spare parts and/or accessories according to the relative frequency of their consumption and displaying said data and/or graphics in according with said frequency.

11. The method as claimed in claim 7, wherein said communications network is associated with Internet services.
